(19) United States
(12) Patent Application Publication
(10) Pub. No.: US 2026/0126143 A1
(43) Pub. Date: May 7, 2026

(54) QUICK RELEASE COUPLER SYSTEM

(71) Applicant: Milton Industries, Inc., Chicago, IL (US)

(72) Inventors: Anne M Brantley, Chicago, IL (US); Andrew Holder Parton, Chicago, IL (US)

(21) Appl. No.: 19/376,646

(22) Filed: Oct. 31, 2025

Related U.S. Application Data
(60) Provisional application No. 63/715,531, filed on Nov. 2, 2024.

(51) Int. Cl. F16L 37/22

(52) U.S. Cl. CPC F16L 37/22

(57) ABSTRACT

A quick release coupler system is provided. The coupler system has a female housing unit having an interior passageway for receiving a fluid, such as grease, from a male housing unit. The interior passageway of the female housing unit has a plurality of pins located within a plurality of cavities. The plurality of pins move from a first position to a second position within the plurality of cavities. The pins of the female housing unit removably lock onto a corresponding male housing unit. Once the female housing unit is locked onto the male housing unit, a fluid passageway between the female housing unit and the male housing unit is created and a fluid may flow from the female housing unit to the male housing unit.

### REFERENCE TO RELATED APPLICATIONS

This application claims priority to U.S. Provisional Application No. 63/715,531 filed on Nov. 2, 2024, the entire contents of which are incorporated by reference herein.

### BACKGROUND OF THE INVENTION

A quick release coupler system is provided. The coupler system has a female housing unit having an interior passageway for receiving a fluid, such as grease, from a male housing unit. The interior passageway of the female housing unit has a plurality of pins located within a plurality of cavities. The plurality of pins move from a first position to a second position within the plurality of cavities. The pins of the female housing unit removably lock onto a corresponding male housing unit. Once the female housing unit is locked onto the male housing unit, a fluid passageway between the female housing unit and the male housing unit is created and a fluid may flow from the female housing unit to the male housing unit.

Couplers for fluids are common. For example, U.S. Publication No.: 20080190489 to Wrubel discloses a chuck for connecting a pressure device to a valve stem of a pressurized vessel includes a body portion having a first passageway that is configured to receive an outer tube portion of a valve stem of a pressurized vessel therein. The body portion has a guide portion at an inner end of the first passageway. A pin element is movably disposed within a second passageway of the body portion and is movable along the coaxial passageways. The pin element extends longitudinally from the guide portion and toward an engaging end of the body portion. The guide portion includes an alignment element at least partially around the second passageway and extending longitudinally toward the engaging end of the body portion and at least partially around the pin element for engaging and supporting an interior portion of the end of the outer tube portion of the valve stem.

Further, U.S. Pat. No. 4,458,719 to Strybel discloses a service connection including a first coupler adapter mounted to a service hose end fitting and a second coupler adapter mounted to a service fitting. In the illustrated embodiment, the adapters are threadedly connected to the hose end fitting and service fitting, respectively, and are provided with structure for effecting a quick connection between the adapters and, thus, between the service hose and service fitting. In one embodiment, the hose fitting adapter defines a rectilinear through passage, and in another embodiment, the hose fitting adapter defines a right angle turn flow passage. The hose fitting adapter is provided, in the illustrated embodiment, with a core depressor for engaging an opening in the core valve of the service fitting upon sealed connection of the adapters. The hose fitting adapter may be provided with a shutoff valve which is adapted to be opened by the engagement of the core depressor thereof with the core valve of the service fitting.

However, these patents fail to describe a quick release coupler system which is easy to use. Further, these patents fail to provide for a quick release coupler system which allows a user to easily and efficiently secure a female housing unit to a male housing unit in the manner described herein.

### SUMMARY OF THE INVENTION

A quick release coupler system is provided. The coupler system has a female housing unit having an interior passageway for receiving a fluid, such as grease, from a male housing unit. The interior passageway of the female housing unit has a plurality of pins located within a plurality of cavities. The plurality of pins move from a first position to a second position within the plurality of cavities. The pins of the female housing unit removably lock onto a corresponding male housing unit. Once the female housing unit is locked onto the male housing unit, a fluid passageway between the female housing unit and the male housing unit is created and a fluid may flow from the female housing unit to the male housing unit.

An advantage of the present quick release coupler system is that the present quick release coupler system is ideal for coupling a male unit and female unit in a fluid line, for example, a grease line or air line.

Another advantage of the present quick release coupler system is that the present quick release coupler system is durable.

And another advantage of the present quick release coupler system is that the present quick release coupler system has movable pins which lock a female housing unit to a male housing unit.

Another advantage of the present system is that the present quick release coupler system is durable. For example, the pins of the present system may be made of a durable steel.

For a more complete understanding of the above listed features and advantages of the quick release coupler system reference should be made to the detailed description and the drawings. Further, additional features and advantages of the invention are described in, and will be apparent from, the detailed description of the preferred embodiments.

### BRIEF DESCRIPTION OF THE DRAWINGS

FIG. 1 illustrates a cross-sectional view of the present female housing unit of the quick release coupler system.

FIG. 2 illustrates an exploded view of the present female housing unit of the quick release coupler system.

FIG. 3 is a cross-sectional view of the terminal end of the male housing unit just prior to entering the female housing unit.

FIG. 4 is a cross-sectional view of the terminal end of the male housing unit in the process of starting to enter the female housing unit wherein the movable sleeve is pulled back.

FIG. 5 is a cross-sectional view of the terminal end of male housing unit inserted into the female housing unit and locked into place. A fluid may then flow from the female housing unit to the male housing unit.

FIG. 6 illustrates a detailed cross-sectional view of the female housing unit and the male housing unit.

FIG. 7A illustrates a side view of one embodiment of a pin of the present system.

FIG. 7B illustrates a perspective view of one embodiment of a pin of the present system.

FIG. 8 is a detailed cross-sectional view of the coupler system wherein the male housing unit is not fully inserted into the female housing unit.

FIG. 9 is a detailed view cross-sectional view of the coupler system wherein the sleeve is pulled back and wherein the male housing unit is not yet secured within the female housing unit.

FIG. 10 is a detailed view cross-sectional view of the coupler system wherein the male housing unit is fully secured within the female housing unit.

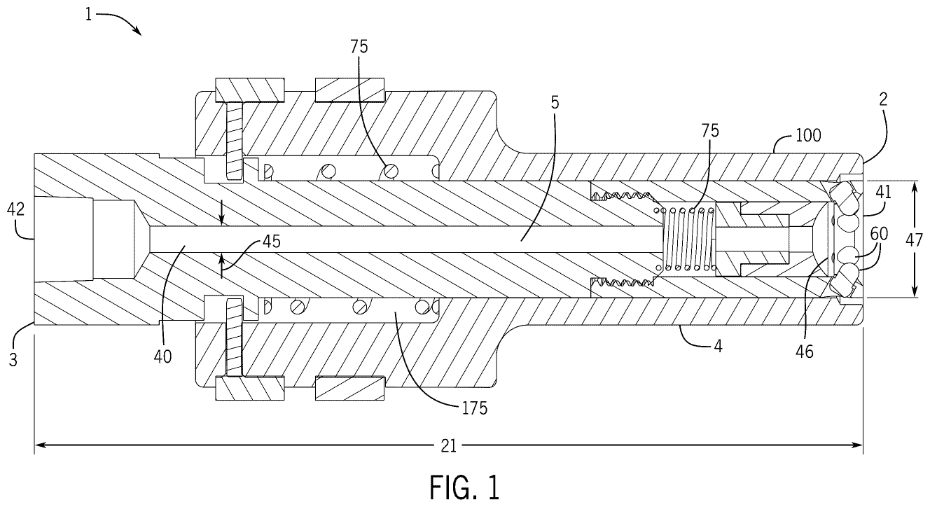

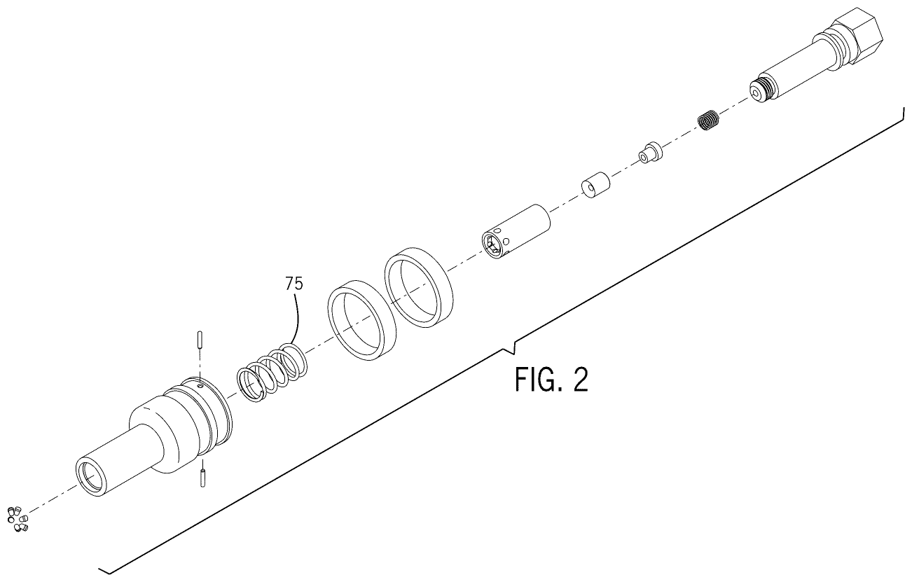

### DETAILED DESCRIPTION OF THE PREFERRED EMBODIMENTS

A quick release coupler system is provided. The coupler system has a female housing unit having an interior passageway for receiving a fluid, such as grease, from a male housing unit. The interior passageway of the female housing unit has a plurality of pins located within a plurality of cavities. The plurality of pins move from a first position to a second position within the plurality of cavities. The pins of the female housing unit removably lock onto a corresponding male housing unit. Once the female housing unit is locked onto the male housing unit, a fluid passageway between the female housing unit and the male housing unit is created and a fluid may flow from the female housing unit to the male housing unit.

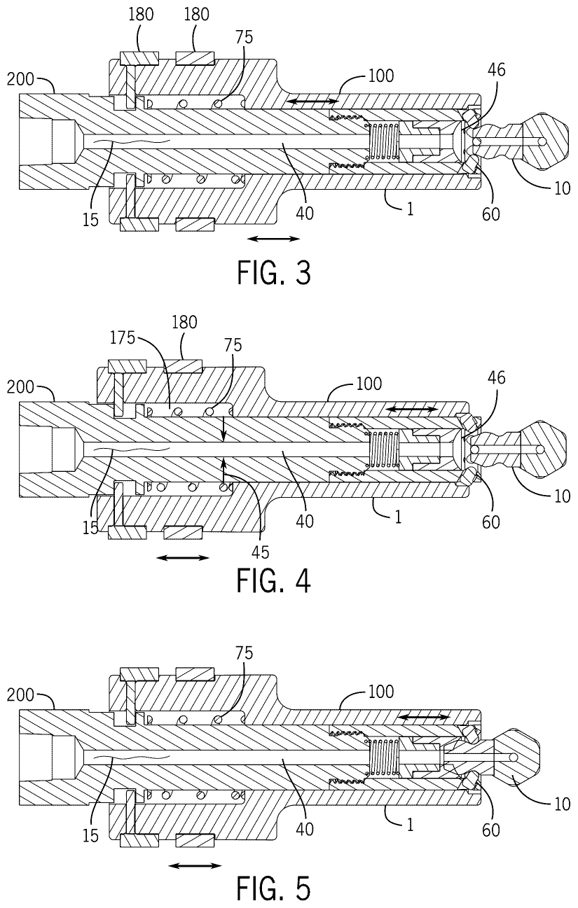

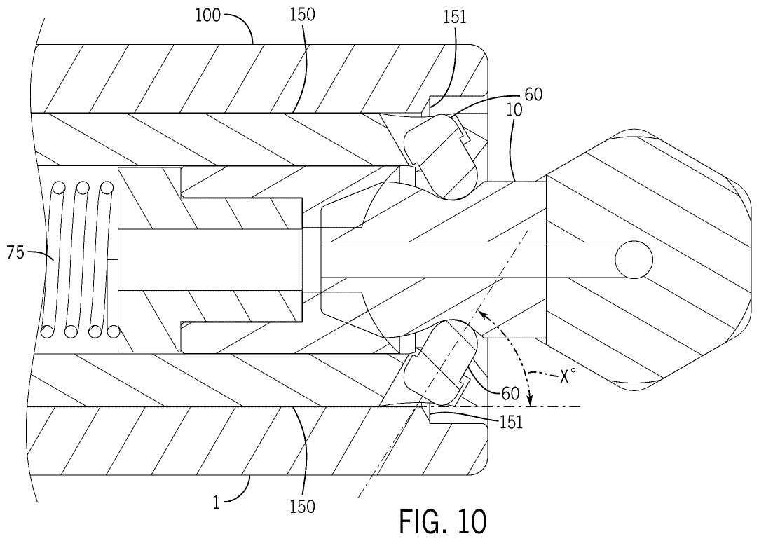

Referring now to the figures, a quick release coupler system is provided. The quick release coupler system has a female housing unit 1 and a male housing unit 10. The female housing unit 1 has a first end 2, a second end 3, a side 4 and an interior 5. The female housing unit 1 may further have an exterior sleeve portion 100 which moves from a first orientation (FIG. 3) to a second orientation (FIG. 4) relative to a stationary shaft portion 200 as shown in FIGS. 3-5. The side 4 of the female unit 1 may have optional protective bumpers 180. Preferably, the side 4 is generally cylindrical. The female housing unit 1 and male housing unit 10 are ideally made of a durable, non-corrosive metal. In one embodiment, the metal is steel. When the female housing unit 1 and the male housing unit 10 are properly connected (as shown in FIGS. 5 and 10) a fluid 15, such as a gas, grease or other liquid may pass from the female housing unit 1 to the male housing unit 10.

Located in the interior 5 of the female housing unit 1 may be a passageway 40. The passageway 40 may extend the entire length 21 of the female housing unit 1 so that a fluid 15 may pass completely through the female housing unit 1 while the female housing unit 1 is in use. The passageway 40 may have a first end 41 and a second end 42 wherein the first end 41 of the passageway 40 is at the first end 2 of the female housing unit 1 and wherein the second end 42 of the passageway 40 is at the second end 3 of the female housing unit 1.

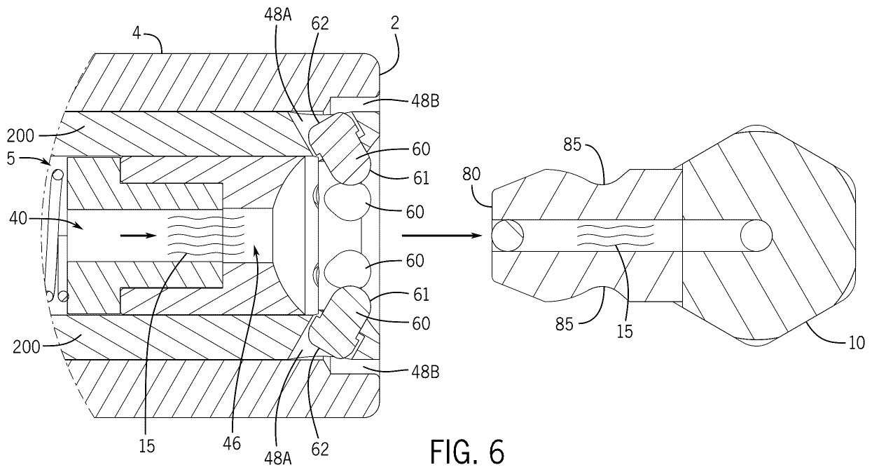

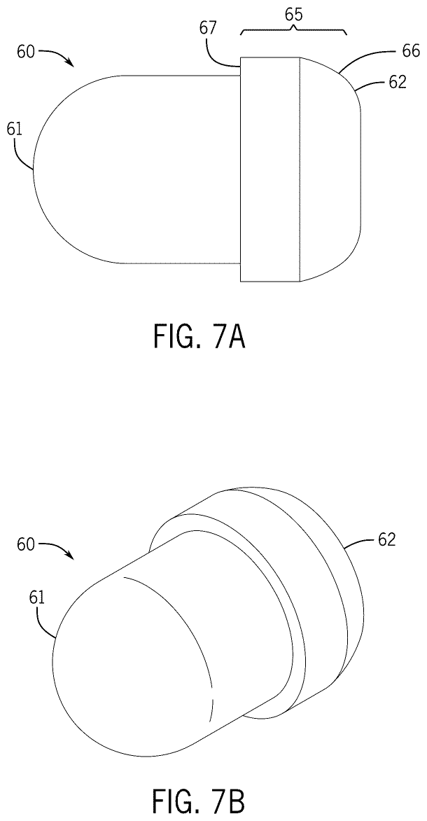

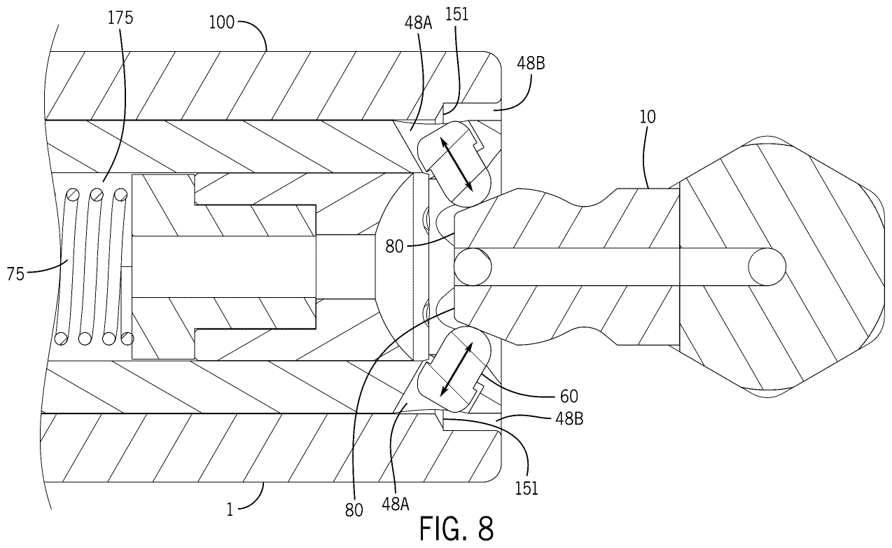

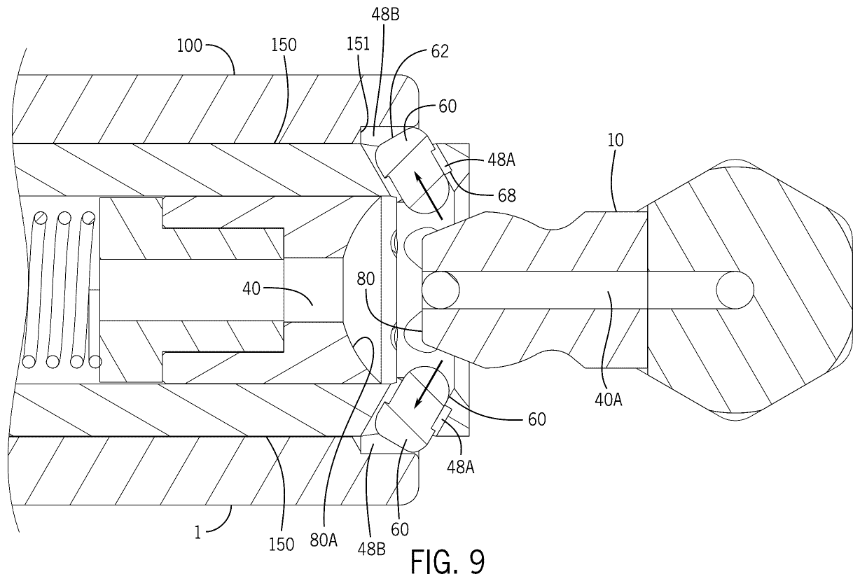

The hollow passageway 40 may have an internal diameter 45. Located at the first end 41 of the passageway 40 may be an extended cavity portion 46 having a larger diameter 47 than the reminder of diameter 45 of most of the passageway 40. Located in or near the extended cavity portion 46 may be a plurality of generally cylindrical hollow spaces 48A as best seen in FIG. 6. The cylindrical hollow spaces 48A are not parallel to the passageway 40. Preferably, the cylindrical hollow spaces 48A are also not perpendicular to the passageway 40. When hollow spaces 48A and 48B align (like in FIGS. 4 and 9), the pins 60 can move up and down within the cylindrical hollow spaces 48A and 48B.

The generally cylindrical hollow spaces 48A may each have a pin 60. The pins 60 may have a first end 61 and a second end 62. The first end 61 of the pins 60 may have a smaller diameter than the second end 62 of the pins 60. The pins 60 may be generally mushroom-shaped wherein the second end 62 has an enlarged head portion 65. The pins 60 may move from a first orientation (FIG. 8) to a second orientation (FIG. 9). Ideally, there are at least three pins 60 located in each of three generally cylindrical hollow spaces 48A; however, the number of pins 60 and hollow spaces 48A may vary depending on the desired function of the coupling system. There is one pin 60 per hollow space 48A. The second end 62 of the pin 60 may have a head portion 65 having a first side 66 and a second side 67 wherein the first side 66 has curved surface at the distal end and wherein the second side has a straight edge 67 at the distal end; wherein the straight edge 67 lacks a curved portion. The straight edge 67 of the second side 62 of the head portion 65 of the pin 60 catches on an extended lip 68 (see FIG. 9) of the female housing unit 1 and therein prevents the pin 60 from becoming separated from the female housing unit 1. The curved first end 66 of the head portion 65 allows the pin 60 to move properly at an angle within the hollow cavities 48. In particular, the curved first end 66 of the head portion 65 increases the amount the pin 60 may move within the hollow spaces 48A as a result of the edges of the first end 66 of the pin 60 not being present to strike portions of the female housing unit 1 and therein restrict movement.

The pins 60 move away from the passageway 40 and farther into the hollow cavities 48 when the terminal end 80 of the male housing unit 10 contacts the first end 61 of the pins 60 as the male housing unit 10 enters the female housing unit 1. As best seen in FIGS. 8 and 9, the coupler system may have an interior surface (or a “ledge”) 150 of the movable sleeve 100. The ledge 150 may have a terminal end 151 which may be near the terminal end 2 of the movable sleeve 100. The terminal end 151 may have an indented hollow portion (the space 48B as described above).

A user first pulls the sleeve 100 backward (toward the second end 3 of the female unit 1) to compress a spring(s) 75 (as discussed below). When the sleeve 100 is pulled back, as the male housing unit 10 may begin to enter the female housing unit 1, the terminal end 80 of the male unit 10 contacts the first end 61 of the pins 60 and first pushes the pins 60 away from the passageway 40 and into hollow spaces 48B. Once the first end 61 of the pins 60 reach an indented ring 85 (as shown in FIG. 6 and as described below) of the male unit 10, the first end 61 of the pins 60 rest within the indented ring 85 of the male unit 10. The sleeve 100 is then released by the user and the spring 75 forces the terminal end 151 of the ledge 150 of the movable sleeve 100 forward to contact the pins 60 and to lock the pins 60 in the second orientation (FIGS. 5 and 10) which therein locks the female housing unit 1 to the male housing unit 10 as further discussed below. To release the male housing unit 10 from the female housing unit 1 the reverse process is followed.

The terminal end 151 of the ledge 150 moves forward and makes contact with and pushes the second end 62 of the pin 60 toward the interior of the female housing unit 1 in the hollow space 48A when the spring(s) 75 of the movable sleeve 100 is released. If the male housing unit 10 is attached to the female housing unit 1 when the movable sleeve 100 is released then the first end 61 of the pins 60 will rest in the indented ring 85 of the male housing unit 10. If the male housing unit 10 is separated from the female housing unit 1 and the movable sleeve 100 is released, then the ledge 151 makes contact with the second end 62 of the pin 60 and force the pins 60 toward the center of the female housing unit 1 wherein the lip 68 stops the pins 60 from becoming disconnected with the female housing unit 1. When the male housing unit 10 is properly secured to the female housing unit 1 the terminal end 80 of the male housing unit 10 makes contact with an inner wall 80A (FIG. 9) of the passageway 40 of the female housing unit 1 so that the hollow passageway 40A of the male housing unit 10 may be in fluid communication with the hollow passageway 40 of the female housing unit 1 and the fluid 15 may then flow between the two units 1, 10.

In an embodiment, the generally cylindrical hollow spaces 48, and the pins 60 located within the generally cylindrical hollow spaces 48, are positioned at an angle with respect to the passageway 40 of the female housing unit 1. In particular, the pins 60 are not perpendicular to the passageway 40. Ideally, the generally cylindrical hollow spaces 48A/48B and the pins 60 located within the generally cylindrical hollow spaces 48A/48B are located at an angle (preferably between forty and eighty degrees, and ideally sixty degrees) with respect to the passageway 40 and the sleeve 100 (FIG. 10). Placing the pins 60 at an angle with respect to the passageway 40 and the movable sleeve 100 allows for improved function of the system, especially the quick connecting and release of the male housing unit 10 with respect to the female housing unit 1. In particular, the terminal end 80 of the male housing unit 10 may more effectively be locked onto and released from the first end 61 of the pins 60 when the pins 60 are located on an angle.

As stated above, the coupler system may have at least one spring 75 (the illustrations show two springs 75 at different locations). One spring 75 may be located around the passageway 40 of the female housing unit 1 and within the exterior sleeve 100. In particular, one spring 75 may be located in a space 175 (FIG. 8) between the passageway 40 and the exterior sleeve 100. The spring 75 is in contact with the sleeve 100. In the relaxed (expanded) state (FIGS. 3 and 5), the sleeve 100 is pushed forward toward the first end 41 of the female housing unit 1. In the relaxed state, the spring 75 pushes the ledge 150 forward (toward the first end 41 of the passageway 40 of the female housing unit 1) so that the terminal end 151 of the ledge 150 forces the pins 60 into the second orientation (FIG. 10). When the sleeve 100 is pulled back by a user (away from the first end 41 of the passageway 40 of the female housing unit 1 as shown in FIGS. 4 and 9) the spring 75 is in the compressed state and the pins 60 may move more freely within the hollow spaces 48A/48B. FIG. 3 illustrates the movable sleeve 100 in the relaxed state and the male housing unit 10 and female housing unit 1 not fully connected, FIG. 4 illustrates the movable sleeve 100 in the compressed state and FIG. 5 shows the movable sleeve 100 in the relaxed state again (this time with the male housing unit 10 fully connected to the female housing unit 1).

Once the male housing unit 10 is secured to the female housing unit 1 (FIGS. 5 and 10) by the pins 60 of the female housing unit 1 grasping and securing the male housing unit 10 at the indented ring 85, the two housing units 1, 10 are then locked together and a fluid 15, such as a grease may pass through the passageways 40/40A. To release the male housing unit 10 from the female housing unit 1, a user pulls the sleeve 100 backward and then pulls the two housing units 1, 10 apart.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

I claim:

1. A quick release coupler system having:
a female housing unit having an exterior surface and an interior passageway having a hollow portion:
a male housing unit having an exterior surface and an interior passageway having a hollow portion;
wherein the interior passageway of the female housing unit has a has at least one cylindrical hollow space and wherein at least one pin is located partially within the cylindrical hollow space of the female housing unit;
wherein the pin moves from a first position to a second position within the cylindrical hollow space of the female housing unit; and
wherein the pin locks the female housing unit to the male housing unit.

2. The quick release coupler system of claim 1 wherein the cylindrical hollow space is not parallel to the interior passageway of the female housing unit.

3. The quick release coupler system of claim 1 wherein the cylindrical hollow space is not perpendicular to the interior passageway of the female housing unit.

4. The quick release coupler system of claim 1 wherein the pin is made of steel.

5. The quick release coupler system of claim 1 wherein the pin has a first end and a second end and wherein the first end and the second end of the pin have different diameters.

6. The quick release coupler system of claim 1 wherein the angle of the cylindrical hollow space is between forty and eighty degrees with respect to the interior passageway of the female housing unit.

7. The quick release coupler system of claim 1 further comprising:
a spring located within the female housing unit wherein the spring surrounds the interior passageway of the female housing unit.

8. The quick release coupler system of claim 1 further comprising:
a movable sleeve surrounding the interior passageway of the female housing unit wherein the movable sleeve moves from a first position to a second position.

9. The quick release coupler system of claim 1 further comprising:
a first end of the male housing unit wherein the first end of the male housing unit has an indented ring and wherein the indented ring receives the pin of the female housing unit.

10. The quick release coupler system of claim 1 further comprising:
a terminal end of a ledge of the movable sleeve wherein the terminal end of the ledge of the movable sleeve has an indented portion forming a space and wherein the space may receive the pin.
